(19) United States
(12) Patent Application Publication
(10) Pub. No.: US 2013/0088170 A1
(43) Pub. Date: Apr. 11, 2013

(54) DRIVING CIRCUIT OF LIGHT EMITTING DIODE AND LIGHT SOURCE APPARATUS

(71) Applicant: Yung-Chen Lu, Hsinchu County (TW)

(72) Inventor: Yung-Chen Lu, Hsinchu County (TW)

(73) Assignee: EXCELLIANCE MOS CORPORATION, Hsinchu County (TW)

(21) Appl. No.: 13/253,982

(22) Filed: Oct. 6, 2011

(51) Int. Cl. H05B 37/02

(52) U.S. Cl. 315/307

(57) ABSTRACT

A driving circuit of a light emitting diode (LED) capable of receiving a power source to supply a driving current to an LED module is provided. The driving circuit includes a first current path and a second current path. The first current path includes a switch. The switch is disposed between the LED module and a terminal. The switch has a control terminal and receives a control signal through the control terminal so as to control whether the LED module is coupled to the terminal via the switch. The second current path is coupled between the LED module and the terminal. The second current path includes an impedance unit and is coupled to the first current path in parallel.

### BACKGROUND OF THE INVENTION

1. Field of the Invention

The invention relates to a driving circuit and a light source apparatus. More particularly, the invention relates to a driving circuit configured for driving a light emitting diode (LED) and a light source apparatus adopting the driving circuit.

2. Description of Related Art

Light emitting diodes (LEDs) have compact volume, save energy, and are durable. LEDs are now more widely adopted as the light source for various products with the advancement and maturation of the fabrication technology thereof. On the other hand, LEDs gradually become the new light source with the promotion for energy saving and carbon reduction. LEDs have low working voltage, are capable of emitting light actively, and maintain a certain brightness. LEDs also include characteristics such as impact tolerance, vibration tolerance, and long life-span (one hundred thousand hours) and are thus popularly applied in various fields. For example, LEDs can be used as the backlight source in a liquid crystal display (LCD).

Generally, the contrast ratio of a display is calculated from the ratio of the highest brightness (unit: cd/m²) and the lowest brightness of a display image. Herein, the dynamic contrast technology shows that the brightness of the backlight source of the display can be adjusted according to the tone of the display image. For example, when an image is displayed in a dark state, the backlight source is dimmed accordingly to prevent light leakage. In addition, as the driving current of the backlight source is adjusted according to the intensity needed by the backlight source, energy can then be saved.

In conventional technology, the brightness of LEDs is adjusted by adjusting the duty cycle of the pulse width modulation (PWM) signal. In details, less current passes through the LEDs in a fixed time period as the duty cycle of the PWM signal becomes shorter, such that the average brightness of the LEDs becomes lower. However, in practical operation, the duty cycle of the PWM signal has its adjustment limit (about 0.1% to 0.5%). Thus, adjusting the current of the LEDs through the PWM signal does not reduce the brightness of the LEDs effectively when an image needs to be displayed in a dark state, so that the display can not represent a good dynamic contrast.

To improve the above issue, one skilled in the art utilizes the linear dimming signal additionally to control the current passing through the LEDs. FIG. 1 shows a schematic diagram of a driving circuit of a conventional LED. As depicted in FIG. 1, a driving circuit 100 includes a linear dimmer 110, an LED 120, a pulse width modulator 130, and a resistor R1. The linear dimmer 110 changes the voltage level of a node A according to a linear dimming signal Sld. Further, when a display displays an image in a dark state, the linear dimmer 110 lowers the voltage level of the node A to decrease the current passing through the resistor R1, thereby reducing the current passing through the LED 120. Hence, the brightness of the LED 120 is reduced. Alternatively, the pulse width modulator 130 switches on or off a switch Q0 by modulating the duty cycle of a PWM signal S_{PWM}, thereby adjusting the brightness of the LED 120. As a result, by modulating the duty cycle of the PWM signal S_{PWM} and lowering the voltage level of the node A from 1 Volt (V) to 0.1 V, the current passing through the LED 120 can be decreased from, for example, 1,000 milli-ampere (mA) to 1 mA. Nonetheless, the reduction of the current passing through the LED 120 remains limited.

### SUMMARY OF THE INVENTION

The invention is directed to a driving circuit of a light emitting diode (LED), where the driving circuit is capable of supplying a small driving current to the LED for emitting light of low brightness.

The invention is directed to a light source apparatus capable of providing a good light and dark contrast.

The invention is directed to a driving circuit of an LED suitable for receiving a power source to supply a driving current to an LED module. The driving circuit includes a first current path and a second current path. The first current path includes a first switch. The first switch is disposed between the LED module and a terminal. The first switch has a first control terminal and receives a control signal through the first control terminal to control whether the LED module is coupled to the terminal via the first switch. The second current path is coupled between the LED module and the terminal. The second current path includes an impedance unit and is coupled to the first current path in parallel.

In one embodiment of the invention, the impedance unit further includes a first resistor.

In one embodiment of the invention, a resistance of the first impedance ranges from 1 mega-ohms to 50 mega-ohms.

In one embodiment of the invention, the terminal is a ground terminal.

In one embodiment of the invention, a first terminal of the first resistor is coupled to the first current path and a second terminal of the first resistor is coupled to the ground terminal.

In one embodiment of the invention, the impedance unit further includes a second switch and a third switch. The second switch is coupled between the first resistor and the ground terminal. The second switch has a second control terminal and receives a direct current signal through the second control terminal. The third switch is coupled between the second control terminal and the ground terminal. The third switch has a third control terminal and receives a failure detection signal through the third control terminal.

In one embodiment of the invention, the first current path further includes a second resistor. The second resistor is coupled between the first switch and the ground terminal.

In one embodiment of the invention, the driving circuit further includes a diode. The diode is coupled between the power source and the first switch.

In one embodiment of the invention, the first current path further includes an inductor. The inductor is coupled between the diode and a capacitor.

In one embodiment of the invention, the power source is an alternating current power source and the terminal is a terminal of the alternating current power source. The first switch and the impedance unit are coupled between the alternating current power source and the LED module in parallel.

In one embodiment of the invention, the impedance unit further includes a third resistor.

In one embodiment of the invention, the impedance unit further includes a fourth switch and a fifth switch. The fourth switch has a fourth control terminal and receives a direct current signal through the fourth control terminal. The fifth switch is coupled between the fourth control terminal and the LED module. The fifth switch has a fifth control terminal and receives a failure detection signal through the fifth control terminal.

The invention is further directed to a light source apparatus suitable for receiving a power source to supply a light source. The light source apparatus includes an LED module and the driving circuit aforementioned. The driving circuit is coupled to the LED module and suitable for receiving a power source to supply a driving current to the LED module.

In light of the foregoing, the driving circuit of the LED illustrated in the invention provides the first current path and the second current path to the driving current. As the impedance unit is disposed on the second current path, the driving current passing through the LED can be decreased, thereby reducing the brightness of the LED effectively. Consequently, the light source apparatus of the invention is capable of providing a good light and dark contrast.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 shows a schematic diagram of a driving circuit of a conventional light emitting diode (LED).

FIG. 2A illustrates a schematic diagram of a light source apparatus according to the first embodiment of the invention.

FIG. 2B illustrates a schematic diagram of an impedance unit in FIG. 2A in another embodiment.

FIG. 3A illustrates a schematic diagram of a light source apparatus according to the second embodiment of the invention.

FIG. 3B is a schematic diagram showing an impedance unit in FIG. 3A in another embodiment.

FIG. 4A depicts a schematic diagram of a light source apparatus according to the third embodiment of the invention.

FIG. 4B is a schematic diagram showing an impedance unit in FIG. 4A in another embodiment.

### DETAILED DESCRIPTION OF DISCLOSED EMBODIMENTS

### First Embodiment

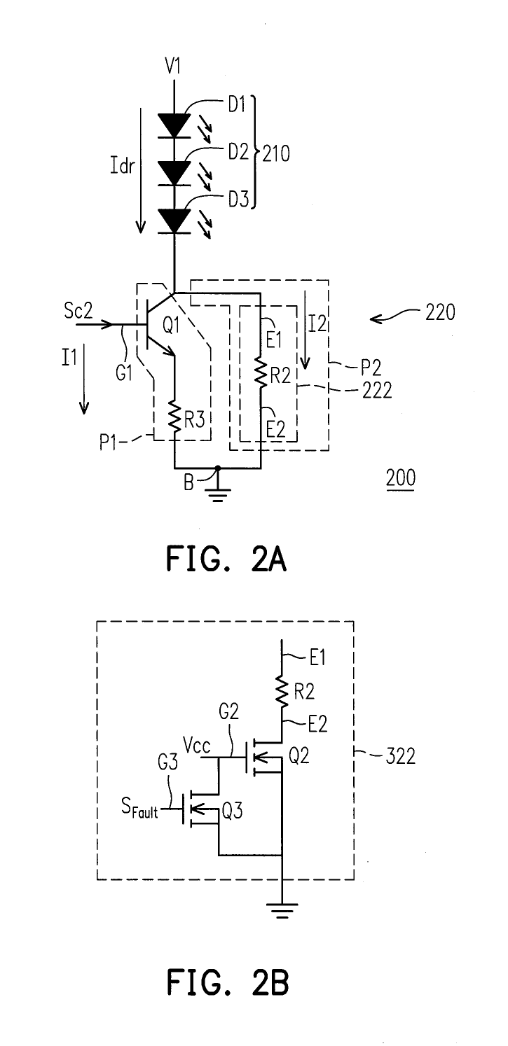

FIG. 2A illustrates a schematic diagram of a light source apparatus according to the first embodiment of the invention. Referring to FIG. 2A, a light source apparatus 200 is suitable for receiving a power source V1 to supply a light source. The light source apparatus 200 includes a light emitting diode (LED) module 210 and a driving circuit 220. The LED module 210 includes a plurality of LEDs D1-D3 (only three LEDs are illustrated herein). The driving circuit 220 is coupled to the LED module 210 and suitable for receiving the power source V1 to supply a driving current Idr to the LED module 210. The driving circuit 220 includes a current path P1 and a current path P2. The current path P1 includes a switch Q1. The switch Q1 is disposed between the LED module 210 and a terminal B, where the terminal B is, for example, a ground terminal. The switch Q1 has a control terminal G1 and receives a control signal Sc2 through the control terminal G1 to control whether the switch Q1 is conducted or not. That is, whether the LED module 210 is coupled to the ground terminal via the switch Q1 is controlled. Here, the switch Q1 is a bipolar junction transistor (BJT) and the control signal Sc2 is a pulse width modulation (PWM) signal, for example. It should be noted that in other embodiments, the switch Q1 can also be a metal-oxide-semiconductor field-effect transistor (MOSFET) or other devices that can be adopted as a switch; however, the invention is not limited thereto. Also, the current path P2 is coupled to the LED module 210 and the ground terminal (that is, the terminal B). The current path P2 includes an impedance unit 222 and is coupled to the current path P1 in parallel. When the switch Q1 is conducted or switched on, the LED module 210 is then coupled to the ground terminal via the switch Q1, so that the driving current Idr flows to the current path P1. When the switch Q1 is not conducted or switched off, the LED module 210 can not be coupled to the ground terminal via the switch Q1 to form a current-conducting channel. As a consequence, the driving current Idr flows from the LED module 210 to the current path P2.

As depicted in FIG. 2A, the impedance unit 222 of the present embodiment includes a resistor R2. A first terminal E1 of the resistor R2 is coupled to the current path P1 and a second terminal E2 of the resistor R2 is coupled to the ground terminal. In addition, the current path P1 further includes a resistor R3 coupled between the switch Q1 and the ground terminal. In the present embodiment, the resistor R2 has high impedance and the resistance thereof is far higher than that of the resistor R3. For instance, the resistor R2 of the present embodiment has a resistance ranging from 1 mega-ohms to 50 mega-ohms, and the resistor R3 has a resistance of 10 ohms.

In details, when the control signal Sc2 is in a logic high level, the switch Q1 is in a conductive state (that is, switched on), so that most of the driving current Idr (that is, a current I1) flows through the current path P1. The other small portion of the driving current Idr (that is, a current I2) flows through the current path P2. In other words, when the switch Q1 is switched on, the current of the driving current Idr substantially equals to a sum of the current on the current path P1 and the current on the current path P2. For example, assuming the power source V1 supplies a 100 Volt (V) direct current (DC) voltage and the LED module 210 has a voltage drop of 90 V, the current I1 is then 1 ampere (A) and the current I2 is 10 micro-ampere (μA). In other words, when the switch Q1 is switched on, the driving current Idr flowing through the LED module 210 is about 1.00001 A, which is very close to the original design of having 1 A of current flowing through.

On the other hand, when the control signal Sc2 is in a logic low level, the switch Q1 is switched off, such that the LED module 210 can not be coupled to the ground terminal via the switch Q1. The current path P1 is thus an open circuit, and the driving current Idr only flows through the current path P2. In other words, when the switch Q1 is switched off, the current of the driving current Idr substantially equals to the current flowing on the current path P2. For example, assuming the power source V1 supplies a 100 V DC voltage and the LED module 210 has a voltage drop of 90 V, the current I1 is then 0 A and the current I2 is 10 μA. That is, when the switch Q1 is switched off, the driving current Idr flowing through the LED module 210 is about 10 μA for the LEDs D1-D3 to display with low brightness. In other words, a display adopting the light source apparatus 200 of the present embodiment is capable of displaying an image in a favored dark state.

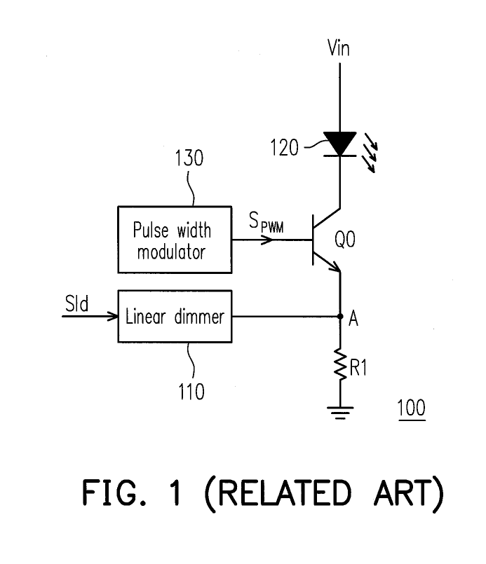

As aforementioned, the brightness of the LEDs D1-D3 is determined by the value of the driving current Idr and a contrast ratio is calculated by dividing a highest brightness of an all white image by a brightness of an all black image. As illustrated in FIG. 1 and the description thereof, the driving current can only be reduced to about 1 mA when the linear dimmer 110 is used in cooperation with the pulse width modulator 130. Here, the contrast ratio that can be attained by the conventional technology is merely 10³ (that is, 1 A/1 mA=10³). However, in the present embodiment, the contrast ratio is about 10⁵ (that is, 1 A/10 μA=10⁵), which is much higher than the contrast ratio of the conventional technology, and the relative dynamic ratio can also be increased. In addition, as the present embodiment does not require the use of the conventional linear dimmer and is capable of obtaining a relatively high dynamic contrast by applying the impedance unit 222 with high impedance, the space for disposing the driving circuit 220 can be decreased so as to reduce the volume of the light source apparatus 200 effectively. However, in other embodiments, the impedance unit 222 can also be disposed with the conventional linear dimmer or the pulse width modulator. Or, these three devices can all be disposed in the apparatus. However, the invention is not limited thereto.

FIG. 2B illustrates a schematic diagram of an impedance unit in FIG. 2A in another embodiment. Referring to FIGS. 2A and 2B simultaneously, in the present embodiment, an impedance unit 322 further includes a switch Q2 and a switch Q3. The switch Q2 is coupled between the resistor R2 and the ground terminal, and the switch Q2 has a control terminal G2 to receive a DC signal Vcc. The switch Q3 is coupled between the control terminal G2 and the ground terminal. The switch Q3 has a control terminal G3 and receives a failure detection signal S_{Fault} through the control terminal G3. Generally, when the light source apparatus 200 is operating normally, the failure detection signal S_{Fault} is usually in a logic low level. When the light source apparatus 200 has failed (i.e. the switch Q1 or the LED D1, D2, or D3 is damaged), the failure detection signal S_{Fault} then shifts from the logic low level to the logic high level. As a result, the switch Q3 is switched on and the switch Q2 is therefore switched off. Hence, the second terminal E2 of the resistor R2 is in a floating state, so that the power source V1 stops supplying the driving current Idr to the LEDs D1-D3 to turn down the LED module 210 completely. In other words, when the light source apparatus 200 having the impedance unit 322 has failed, the light source apparatus 200 is then turned off completely for a display panel using the light source apparatus 200 to show an all black state so as to save power and alert on failure.

### Second Embodiment

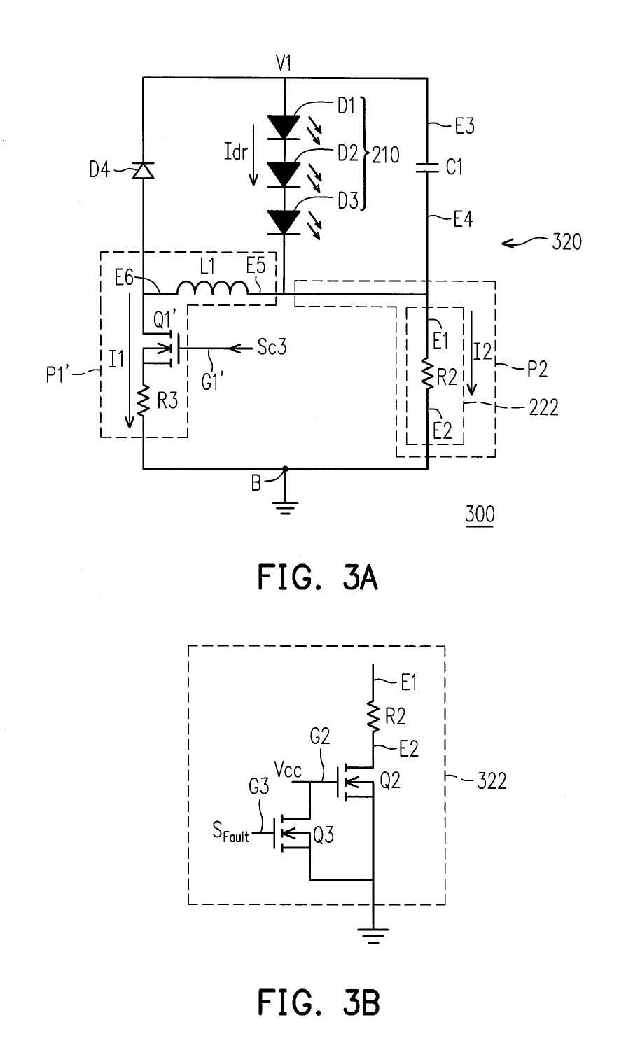

FIG. 3A illustrates a schematic diagram of a light source apparatus according to the second embodiment of the invention. A light source apparatus 300 of the present embodiment is similar to the light source apparatus in FIG. 2A. The main difference between the two is that a driving circuit 320 further includes a diode D4 and a current path P1′ further includes an inductor L1. Also, the driving circuit 320 includes a capacitor C1 as a filter.

As shown in FIG. 3A, the diode D4 is coupled between the power source V1 and a switch Q1′. The capacitor C1 is coupled between the power source V1 and the impedance unit 222. The inductor L1 is coupled between the diode D4 and the capacitor C1. A resistor R3 is coupled between the switch Q1′ and the ground terminal. Furthermore, two terminals of the LED module 210 and two terminals of the capacitor C1 are coupled to each other. The LED module 210, the diode D4 and the capacitor C1 are all coupled to the power source V1. In details, a first terminal E3 of the capacitor C1 is coupled to the power source V1 and a second terminal E4 of the capacitor C1 is coupled to the first terminal E1 of the resistor R2. A first terminal E5 of the inductor L1 is coupled to the first terminal E1 of the resistor R2. A second terminal E6 of the inductor L1 is coupled to the switch Q1′. In the present embodiment, the switch Q1′ is, for example, a metal-oxide-semiconductor field-effect transistor (MOSFET).

Similarly, when a control signal Sc3 is in a logic high level, the switch Q1′ is conductive (that is, switched on). That is, the LED module 210 can be coupled to the terminal B (that is, the ground terminal) via the switch Q1′ to form a current-conducting channel, such that most of the driving current Idr (that is, the current I1) flows through the current path P1′. The other small portion of the driving current Idr (that is, a current I2) flows through the current path P2. At this time, a display utilizing the light source apparatus 300, for instance, displays an image in a bright state.

On the other hand, when the control signal Sc3 is in a logic low level, the switch Q1′ is switched off, such that the LED module 210 can not be coupled to the ground terminal via the switch Q1′. The current path P1′ is thus an open circuit, and the driving current Idr only flows through the current path P2. As the current I2 at this time is a small current, a display adopting the light source apparatus 300 can show an image in a dark effectively. Additionally, in the present embodiment, since the difference between a largest value and a smallest value of the driving current Idr flowing through the LED module 210 can be great, the light source apparatus can provide a high light and dark contrast. As a result, the display applying the light source apparatus 300 of the invention can have a better dynamic contrast.

Also, as the present embodiment does not require the use of the conventional linear dimmer and is capable of obtaining a relatively high dynamic contrast by applying the impedance unit 222 with compact volume and high impedance, the space for disposing the driving circuit 320 can be decreased so as to reduce the volume of the light source apparatus 300 effectively. However, in other embodiments, the impedance unit 222 can also be disposed with the conventional linear dimmer or the pulse width modulator. Or, these three devices can all be disposed in the apparatus. Nevertheless, the invention is not limited thereto.

FIG. 3B is a schematic diagram showing an impedance unit in FIG. 3A in another embodiment. Referring to FIGS. 3A and 3B simultaneously, in the present embodiment, the impedance unit 322 further includes the switch Q2 and the switch Q3. The switch Q2 is coupled between the resistor R2 and the ground terminal, and the switch Q2 has the control terminal G2 to receive a DC signal Vcc. The switch Q3 is coupled between the control terminal G2 and the ground terminal. The switch Q3 has a control terminal G3 and receives a failure detection signal S_{Fault} through the control terminal G3. Generally, when the light source apparatus 300 is operating normally, the failure detection signal S_{Fault} is usually in a logic low level. When the light source apparatus 300 has failed (i.e. the switch Q1 or the LED D1, D2, or D3 is damaged), the failure detection signal S_{Fault} then shifts from the logic low level to the logic high level. As a result, the switch Q3 is switched on and the switch Q2 is therefore switched off. Hence, the second terminal E2 of the resistor R2 is in a floating state, so that the power source V1 stops supplying the driving current Idr to the LEDs D1-D3 to turn down the LED module 210 completely. In other words, when the light source apparatus 300 having the impedance unit 322 has failed, the light source apparatus 300 is then turned off completely for a display panel using the light source apparatus 300 to show an all black state so as to save power and alert on failure.

### Third Embodiment

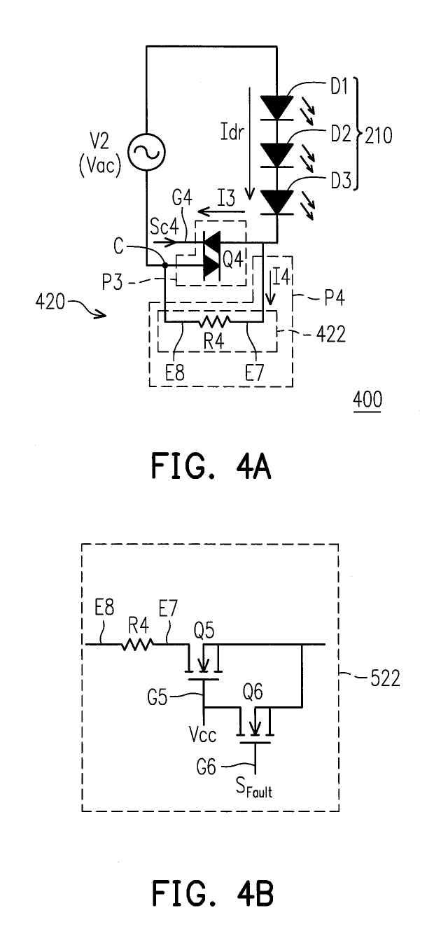

FIG. 4A depicts a schematic diagram of a light source apparatus according to the third embodiment of the invention. Referring to FIG. 4A, a light source apparatus 400 is suitable for receiving a power source V2 to supply a light source. The light source apparatus 400 includes an LED module 210 and a driving circuit 420. The LED module 210 includes a plurality of LEDs D1-D3 (only three LEDs are illustrated herein). The driving circuit 420 is coupled to the LED module 210 and suitable for receiving the power source V2 to supply a driving current Idr to the LED module 210. The driving circuit 420 includes a current path P3 and a current path P4. The current path P3 includes a switch Q4. The switch Q4 is disposed between the LED module 210 and a terminal C. The switch Q4 has a control terminal G4 and receives the control signal Sc3 through the control terminal G4 to control whether the switch Q4 is switched on or off. That is, whether the LED module 210 is coupled to the terminal C through the switch Q4 is controlled. Here, the terminal C in the present embodiment is a terminal of the power source V2.

Moreover, the current path P4 includes an impedance unit 422 and the current path P4 and the current path P3 are coupled between the power source V2 and the LED module 210 in parallel. When the switch Q4 is conducted (that is, switched on) for the LED module 210 to be coupled to a terminal of the power source V2 through the switch Q4, the driving current Idr then flows through the current path P3. When the switch Q4 is switched off, as the LED module 210 can not be coupled to the power source V2 through the switch Q4, the driving current Idr only flows through the current path P4.

In the present embodiment, the power source V2 is an alternating current power source Vac, for example, and the switch Q4 and the impedance unit 422 are coupled between the alternating current (AC) power source Vac and the LED module 210 in parallel. In the present embodiment, the switch Q4 adopts a tri-electrode AC (TRIAC) switch to implement the functions thereof. However, the invention is not limited thereto. Further, an illumination value for the switch to adjust the light source correspondingly can be divided into several levels. Here, each level corresponds to a different delay angle α. As the delay angle α becomes larger, a conductive angle becomes smaller, which means the switch Q4 is switched off for a longer period of time. Besides, the power source V2 can be a commercial AC power source or a power source supplied by a power supply, but is not limited thereto.

As depicted in FIG. 4A, the impedance unit 422 of the present embodiment includes a resistor R4. A first terminal E7 of the resistor R4 is coupled to the current path P3, and a second terminal E8 of the resistor R4 is coupled to the power source V2. In the present embodiment, the resistor R4 has a high impedance ranging from 1 mega-ohms to 50 mega-ohms. The current flowing through the resistor R4 is thus small for the LEDs D1-D3 to emit light of low brightness.

In details, when a control signal Sc4 is in a logic high level, the switch Q4 is in a conductive state (that is, switched on), so that most of the driving current Idr (that is, a current I3) flows through the current path P3. The other smaller portion of the driving current Idr (that is, a current I4) flows through the current path P4. In other words, when the switch Q4 is switched on, the current of the driving current Idr substantially equals to a sum of the current on the current path P3 and the current on the current path P4. The value of the current I2 is minimal and thus can be neglected, so that the driving current Idr approximates the value of the current I3. As the switch Q4 has low impedance, sufficient current can then passes through the switch Q4, such that the LED module 210 has the sufficient driving current Idr to emit light of high brightness.

On the other hand, when the control signal Sc4 is in logic low level, the switch Q4 is switched off, so that the current path P3 is an open circuit and the driving current Idr only flows through the current path P4. In other words, when the switch Q4 is switched off, the current of the driving current Idr substantially equals to the current on the current path P4. At this time, as the resistor R4 has high impedance, only a small portion of the current I4 flows through the current path P4. Therefore, the LED module 210 is only driven by a small driving current Idr, such that the LEDs D1-D3 can emit light of low brightness. It should be noted that in FIG. 4A, although the driving current Idr, the currents I3 and I4 flow to the AC power source Vac in a clockwise orientation, the driving current Idr, and the currents I3, 14 can also flow to the AC power source Vac in a counter-clockwise orientation. Furthermore, flowing directions of the driving current Idr and the currents I3 and I4 differ according to a polarity of an output voltage of the AC power source Vac, where only one of the conditions is illustrated in FIG. 4A.

Similar to the first embodiment, the present embodiment adopts the impedance unit 422 with high impedance, so that the LEDs D1-D3 can emit with low brightness without affecting the high brightness performance of the LEDs D1-D3. Therefore, a display utilizing the light source apparatus 400 in the present embodiment is capable of displaying better dark and bright images, thereby achieving a high dynamic contrast. Also, as the present embodiment does not require the use of the conventional linear dimmer and is capable of obtaining a relatively high dynamic contrast by applying the impedance unit 422 with compact volume, the space for disposing the driving circuit can be decreased so as to reduce the volume of the light source apparatus 400 effectively.

FIG. 4B is a schematic diagram showing an impedance unit in FIG. 4A in another embodiment. Referring to FIGS. 4A and 4B simultaneously, in the present embodiment, an impedance unit 522 further includes a switch Q5 and a switch Q6. The switch Q5 is coupled between the resistor R4 and the LED module 210, and the switch Q5 has a control terminal G5 to receive a DC signal Vcc. The switch Q6 is coupled between the control terminal G5 and the LED module 210. The switch Q6 has a control terminal G6 and receives a failure detection signal S_{Fault} through the control terminal G6.

Generally, when the light source apparatus 400 is operating normally, the failure detection signal S_{Fault} is usually in a logic low level. When the light source apparatus 400 has failed (i.e. the switch Q4 or the LED D1, D2, or D3 is damaged), the failure detection signal S_{Fault} then shifts from the logic low level to the logic high level. As a result, the switch Q6 is switched on and the switch Q5 is therefore switched off. Hence, the first terminal E7 of the resistor R4 is in a floating state, so that the power source V2 stops supplying the driving current Idr to the LEDs D1-D3 for turning down the LED module 210 completely. In other words, when the light source apparatus 400 having the impedance unit 522 has failed, the light source apparatus 400 is then turned off completely for the display panel using the light source apparatus 400 to show an all black state so as to save power and alert on failure.

In summary, the driving circuit of the LED illustrated in the invention provides two current paths to the driving current. As an impedance unit with high impedance is disposed on one of the current paths, the current flowing through the LED can be decreased, thereby reducing the brightness of the LED effectively. Consequently, the light source apparatus of the invention is capable of providing a good light and dark contrast. Furthermore, as the impedance unit has compact volume, the light source apparatus and the driving circuit of the invention also have compact volume.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving circuit of a light emitting diode (LED) suitable for receiving a power source to supply a driving current to an LED module, the driving circuit comprising:
a first current path comprising a first switch disposed between the LED module and a terminal, the first switch having a first control terminal and receiving a control signal through the first control terminal to control whether the LED module is coupled to the terminal via the first switch; and
a second current path coupled between the LED module and the terminal, the second current path comprising an impedance unit and coupled to the first current path in parallel.

2. The driving circuit as claimed in claim 1, wherein the impedance unit comprises a first resistor.

3. The driving circuit as claimed in claim 2, wherein a resistance of the first resistor ranges from 1 mega-ohms to 50 mega-ohms.

4. The driving circuit as claimed in claim 2, wherein the terminal is a ground terminal.

5. The driving circuit as claimed in claim 4, wherein a first terminal of the first resistor is coupled to the first current path and a second terminal of the first resistor is coupled to the ground terminal.

6. The driving circuit as claimed in claim 4, wherein the impedance unit further comprises:
a second switch coupled between the first resistor and the ground terminal, the second switch having a second control terminal and receiving a direct current signal through the second control terminal; and
a third switch coupled between the second control terminal and the ground terminal, the third switch having a third control terminal and receiving a failure detection signal through the third control terminal.

7. The driving circuit as claimed in claim 4, wherein the first current path further comprises a second resistor coupled between the first switch and the ground terminal.

8. The driving circuit as claimed in claim 7, further comprising a diode coupled between the power source and the first switch.

9. The driving circuit as claimed in claim 8, wherein the first current path further comprises an inductor coupled between the diode and a capacitor.

10. The driving circuit as claimed in claim 1, wherein the power source is an alternating current power source, the terminal is a terminal of the alternating current power source, and the first switch and the impedance unit are coupled between the alternating current power source and the LED module in parallel.

11. The driving circuit as claimed in claim 10, wherein the impedance unit comprises a third resistor.

12. The driving circuit as claimed in claim 11, wherein the impedance unit further comprises:
a fourth switch coupled between the third resistor and the LED module, wherein the fourth switch has a fourth control terminal and receives a direct current signal through the fourth control terminal; and
a fifth switch coupled between the fourth control terminal and the LED module, the fifth switch having a fifth control terminal and receiving a failure detection signal through the fifth control terminal.

13. A light source apparatus suitable for receiving a power source to supply a light source, the light source apparatus comprising:
a light emitting diode (LED) module; and
a driving circuit coupled to the LED module suitable for receiving the power source to supply a driving current to the LED module, the driving circuit comprising:
a first current path comprising a first switch disposed between the LED module and a terminal, the first switch having a first control terminal and receiving a control signal through the first control terminal to control whether the LED module is coupled to the terminal via the first switch; and
a second current path coupled between the LED module and the terminal, the second current path comprising an impedance unit and coupled to the first current path in parallel.

14. The light source apparatus as claimed in claim 13, wherein the impedance unit comprises a first resistor.

15. The light source apparatus as claimed in claim 14, wherein a resistance of the first resistor ranges from 1 mega-ohms to 50 mega-ohms.

16. The light source apparatus as claimed in claim 14, wherein the terminal is a ground terminal.

17. The light source apparatus as claimed in claim 16, wherein a first terminal of the first resistor is coupled to the first current path and a second terminal of the first resistor is coupled to the ground terminal.

18. The light source apparatus as claimed in claim 16, wherein the impedance unit further comprises:
a second switch coupled between the first resistor and the ground terminal, the second switch having a second control terminal and receiving a direct current signal through the second control terminal; and
a third switch coupled between the second control terminal and the ground terminal, the third switch having a third control terminal and receiving a failure detection signal through the third control terminal.

19. The light source apparatus as claimed in claim 16, wherein the first current path further comprises a second resistor coupled between the first switch and the ground terminal.

20. The light source apparatus as claimed in claim 19, further comprising a diode coupled between the power source and the first switch.

21. The light source apparatus as claimed in claim 20, wherein the first current path further comprises an inductor coupled between the diode and a capacitor.

22. The light source apparatus as claimed in claim 13, wherein the power source is an alternating current power source, the terminal is a terminal of the alternating current power source, and the first switch and the impedance unit are coupled between the alternating current power source and the LED module in parallel.

23. The light source apparatus as claimed in claim 22, wherein the impedance unit comprises a third resistor.

24. The light source apparatus as claimed in claim 23, wherein the impedance unit further comprises:
a fourth switch coupled between the third resistor and the LED module, wherein the fourth switch has a fourth control terminal and receives a direct current signal through the fourth control terminal; and
a fifth switch coupled between the fourth control terminal and the LED module, the fifth switch having a fifth control terminal and receiving a failure detection signal through the fifth control terminal.
